(19) United States
(12) Patent Application Publication
(10) Pub. No.: US 2009/0230119 A1
(43) Pub. Date: Sep. 17, 2009

(54) Towel Warmer Device

(76) Inventor: Colyer Lee Dupont, San Francisco, CA (US)

Correspondence Address: JOHN C. MERCHANT, 1128 Regent Street, Suite A, Alameda, CA, 94501, US

(21) Appl. No.: 12/050,155

(22) Filed: Mar. 17, 2008

(51) Int. Cl. H05B 3/06; H05B 3/02

(52) U.S. Cl. 219/521; 219/385

(57) ABSTRACT

An improved towel warmer comprising a generally rectangular, water resistant, flexible, low cost, energy-efficient, and easily stowable electric heating member that releasably attaches to, and hangs from a support member such as a towel rack using one or more releasable straps. The heating member has an electric supply cord that attaches to a wall outlet or battery. The temperature of the heating member is controlled through use of the electric current controller which is attached to the electric supply cord and which may be used to automatically control the wattage and duration of the electric current flowing to the heating member. Once the heating member is attached to the support member and connected to electric current, a towel is hung over the support member so that opposing sides hang next to opposite sides of the member. The heating member is powered on and a towel heated for comfortable use, and then dried after usage. The heating member may then be turned off manually or configured to automatically shut off after a pre-configured period of time.

### CROSS-REFERENCE TO RELATED APPLICATIONS

None

### FEDERALLY SPONSORED RESEARCH

Not Applicable

### SEQUENCE LISTING OR PROGRAM

Not Applicable

### BACKGROUND OF INVENTION

1. Field of Invention

This invention relates to the warming of towels to provide a user with a soothing and warming experience when leaving a bath or shower. This invention is a device and method for warming towels through use of an electrically-powered, flat, rectangular heating member that hangs below a support member such as a towel rod or rack. The device also dries towels after use, to help prevent mildew and facilitate rapid, hygienic and comfortable reuse of towels, including towels that have been folded in half to save space.

2. Prior Art

Typical towel warming devices consist of bulky built-in cabinets or enclosures which are heated through use of steam, water, air, oil, or other means, see U.S. Pat. No. 1,409,877, U.S. Pat. No. 2,831,268, U.S. Pat. No. 3,849,629, U.S. Pat. No. 4,117,309, and U.S. Pat. No. 4,927,995. Some utilize heavy non-flexible heating members such as heated water or steam pipes, see U.S. Pat. No. 2,831,268 and U.S. Pat. No. Des. 324,620. Others utilize steam or air-heated members which require substantial infrastructure to produce enough radiating heat to warm the towel, see U.S. Pat. No. 5,842,287. Most of these devices are non-portable or difficult to stow and are designed for built-in installations. The present invention is designed to provide a relatively simple, safe, portable, easily storable, energy-efficient and low-cost device to achieve the desired intent of warming a towel.

### OBJECTS AND ADVANTAGES

Several objects and advantages of the present invention are to provide a towel warmer that:

a) is easily portable and storable;

b) is easily attached to any existing towel rack;

c) does not require a cabinet enclosure;

d) is quiet;

e) is energy-efficient;

f) is safe to use;

g) is aesthetically pleasing and can be produced in a variety of sizes and colors;

h) warms the entire length of the towel;

i) heats the towel quickly;

j) is inexpensive to manufacture;

h) is flexible;

i) can be easily adjusted for heat; and

j) has an automatic turn-off.

Further objects and advantages are to provide a towel warmer which is simple to use, can fit easily into a suitcase or travel bag, and can be used to warm and dry other items such as articles of clothing. Still further objects and advantages will become apparent from a consideration of the ensuing description and drawings.

### SUMMARY

The present invention is a towel warmer that utilizes a relatively flat, rectangular, flexible, water-resistant electric heating pad which may be easily attached to, and removed from, a towel rack or rod to warm towels.

### DRAWINGS—FIGURES

FIG. 1 is a front view of the towel warmer in a hanging position.

FIG. 2 is a side view of the towel warmer in a hanging position.

FIG. 3 is a front view of an alternative design for the towel warmer in a hanging position.

### DRAWINGS—REFERENCE NUMERALS

1—support member

2—heating member

3—first type of attachment

4—second type of attachment

5—electric current supply cord

6—electric current controller

7—electric power supply plug

### DETAILED DESCRIPTION OF DRAWINGS

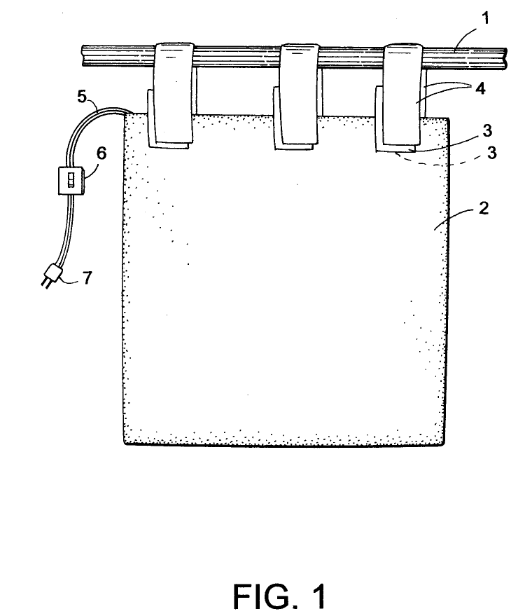

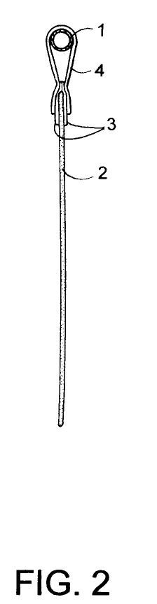

### Preferred Embodiment—FIGS. 1 and 2

FIG. 1 (front view) and FIG. 2 (side view) depict one form of a preferred embodiment of the present invention. The elongated heating member 2 is a pad that is generally rectangular in shape, is flexible, and has a water-resistant outer covering such as rubber or vinyl. It warms by converting electricity into heat as seen in commonly available heating pads used for therapeutic and body warming usage. It is capable of being easily hung from a support member 1 and left on the support member 1 for repeated usage, or easily removed for transport or storage. The heating member 2 has an electric current supply cord 5 which extends from—and provides electric current to—the heating member 2. The electric current supply cord 5 has an electric current controller 6 for controlling electrical current to the heating member 2 and an electric power supply plug 7 for attaching the electric current supply cord 5 to an electrical power source such as a wall outlet or battery. In the preferred embodiment, a first type of attachment 3 is permanently attached to and located on opposite sides of the heating member 2 along one edge. A second type of attachment 4 is then releasably attached to the first type of attachment 3 on one side of the heating member 2, looped over a support member 1 and attached to the first type of attachment 3 on the opposite side of the heating member 2. In the preferred embodiment, the first and second types of attachments utilize a releasable hook and loop system (such as the Velcro™ brand system) where the hook material is used for the first type of attachment 3 and loop material is used as the second type of attachment 4. This second type of attachment means 4 act as straps which allow the heating member 2 to hang vertically below, and parallel to, support member 1. The second type of attachment 4 (that comprise the straps) have opposite ends. One end of each second type of attachment 4, is releasably attached to the first type of attachment 3 located on one side of the heating member 2 and the other end of each second type of attachment 4 is releasably attached to the first type of attachment 3 located on opposite side of the heating member 2. There can be any combination of one or more first and second types of attachment as long as they work together to securely attach the heating member 2 to the support member 1 with one edge of the heating member 2 hanging below, and parallel to, support member 1.

FIG. 1 depicts one form of the preferred embodiment with a system utilizing six squares of the first type of attachment 3 affixed equidistant along one edge of the heating member, three along one edge of one side of the heating member 2, and three along the same edge on the opposite side of the heating member 2. There are three of the second type of attachment 4 (which comprise the straps). These second type of attachments 4 are attached at one end to one of the first type of attachment 3, looped over a support member 1, and then attached at the other end to the first type of attachment 3 located at relative opposite position along the opposite side of the heating member 2. This allows the user to drape a towel over the support member 1, thus allowing the length of the towel to hang against each side of the heating member 2.

The heating member 2 depicted in FIG. 1 is generally flat, has a front and back side, and is generally rectangular. Its size is generally relative to the size of the towel that the user intends to warm. In the preferred embodiment, the heating member 2 is approximately half the length and half the width of a standard sized bath towel that has been folded in half lengthwise.

The heating member 2 is flexible and covered with a heat transferable but water-resistant outer covering such as a vinyl, or rubber. Generally, it is designed to heat uniformly along the entire width and length on both sides. In the preferred embodiment, the heating member 2 is of sufficient size and wattage to comfortably heat a standard bath towel that is folded in half lengthwise.

The electric current supply cord 5 may be of any length. In the preferred embodiment, the electric current supply cord 5 is less than four feet in length for the sake of convenience and ease of use. It is long enough to extend from a towel rack to a nearby outlet, but not so long as to make it cumbersome to stow or pack.

The electric current supply cord 5 is attached to the heating member 2 on one corner end and has an electric power supply plug 7 on the opposite end which allows the device to be plugged into and obtain electric current from a electric power source such as a wall outlet or battery.

The electric current supply cord 5 has an electric current controller 6 which controls the electric current flowing from an electric power source to the heating member 2. It may be a simple on/off switch, or have an adjustable temperature setting mechanism. In the preferred embodiment, the electric current controller 6 will turn off the electric current automatically after a set amount of time, thus increasing the safety and efficiency of the device.

FIG. 2 depicts a side view of one form of the preferred embodiment of the invention attached to a towel rack.

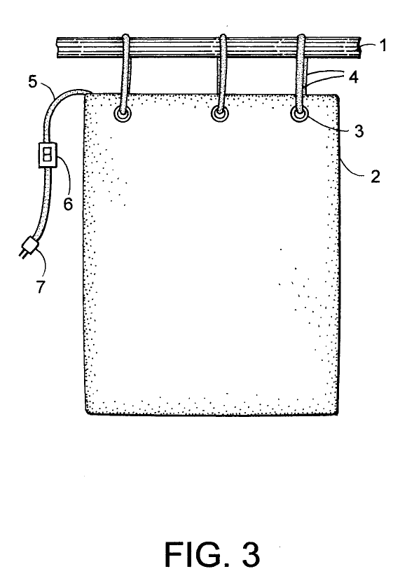

### Alternative Embodiment—FIG. 3

FIG. 3 depicts an alternative embodiment of the invention. In this embodiment, the first type of attachment 3 is one or more grometted holes spread along one edge of the heating member 2. The second type of attachment 4 is one or more straps which may be threaded through the first type of attachment 3 and looped over a support member 1 with the opposite ends of second type of attachment 4 tied together or otherwise connected to form a loop through the first type of attachment and over the support member 1. The method in which the second type of attachment 4 may be attached to the first type of attachment 3 varies. The second type of attachment 4 may be knotted and/or secured at the grometted hole (the first type of attachment 3) or may be looped through the grometted hole, or the ends of the strap connected to form a supporting loop over support member 1.

### Operation—FIGS. 1, 2, and 3

The manner of using the preferred embodiment of the present device as described in FIGS. 1 and 2 is to affix the heating member 2 to a support member 1 by either affixing an end of one or more second type of attachment 4 to one side of one or more first type of attachment 3, looping the one or more second type of attachment 4 over the support member 1 and attaching the opposite end of the one or more second type of attachment 4 to the one or more first type of attachment 3 located along the edge on the opposite side of the heating member 2. A towel is then placed over the support member 1 such that half of the towel hangs along one side of the heating member 2 and the other half of the towel hangs along the opposite side of the heating member 2. The electric current supply cord 5 is then plugged into a power source using the electric power supply plug 7 and the electric current is controlled using the electric current controller 6.

The manner of using the alternative embodiment of the present device as described in FIG. 3 is similar to that using the preferred embodiment except that the second type of attachment 4 (i.e. the straps) are threaded through the first type of attachment 3 (i.e. the grometted holes) looped over the support member 1 and the opposite ends of the second type of attachment 4 are secured together. Alternatively, the second type of attachment 4 (i.e. the straps) has a hook and loop system for attaching the straps to themselves at or near the ends, of each strap, thereby securing heating member 2 below, and parallel to, the support member 1.

### Advantages

From the description above, a number of advantages of this improved towel warmer become evident. This improved towel warmer is easily portable and storable because it is flat, flexible, and can be rolled-up and put into a suitcase or handbag. This improved towel warmer may be easily attached to a towel rack by use of several embodiments of easily securable and releasable attachment means. Of course, an extension cord may be used to elongate the electric current supply cord 5. The improved towel warmer is quiet because it uses radiating heat without the use of steam or air circulating devices (such as utilized in other patents). It is also energy-efficient because it uses only a small amount of electricity and the wattage may be adjusted by the user to achieve varying heat levels; in addition, the towel warmer may also incorporate an automatic shut-off feature, for energy efficiency. The towel warmer is safe to use because it doesn't utilize steam or heated rods which can cause burns to users and the heating member 2 may be made water-tight and safe to use with soaking wet towels. The towel warmer is space-saving in that it helps to dry towels that have been compactly folded in half lengthwise, to help prevent mildew and allow users to more rapidly reuse towels which have been compactly hung at double thickness. The outer covering of the heating member 2 can be produced in a variety of colors and patterns—thus making it aesthetically pleasing. Compared to built-in prior art alternatives, the improved towel warmer is compact and can be easily stored when not in use. It is generally capable of warming the entire length of a towel. It is relatively easy and inexpensive to manufacture, and can be used for a variety of purposes in addition to warming towels.

While the above description details the preferred embodiment, one alternative embodiment, and a preferred method for using both, it is to be understood that the towel warmer is not limited in its application to the details of construction and arrangement of parts illustrated in the accompanying drawings, since it is capable of other embodiments and of being practiced in various ways. Variations and modifications may be made by those skilled in the art to the disclosed embodiments, with the attainment of some or all of its advantages and without departing from the spirit and nature of the invention. By way of example, an alternative embodiment may have an electric current supply cord 5 enter at the bottom corner instead of at top (as shown in all three drawings). This is alternative may be more convenient for use by someone who has a wall socket (or battery) that is near the floor and below the towel rack. Another alternative is to have the first type of attachment 3 located along more than one edge of the heating member 2, thus giving the user the option of hanging the heating member 2 in a configuration that allows the electric current supply cord 5 to be nearest the wall socket (or battery). Another alternative embodiment is to combine the first and second types of attachment (3 and 4) into single or multiple flaps of material extending from one side of the heating member 2 and along an edge of the heating member 2 which may be looped over a support member 1 and be releasably attached to the heating member 2 on the opposite side of the heating member 2 along the same edge using a releasable attachment such as snaps or hook and loop attachment systems. In essence the flap acts as one long strap which is permanently attached to one side of the heating member. Another alternative embodiment is to have a heating member 2 that is made of a stiff material which may not be rolled, but which might instead be folded or stored flat.

Thus the scope of the invention should be determined by the appended claims and their legal equivalents rather than by the examples given.

What is claimed is:

1. A towel warmer comprising:
an elongated heating member comprising a generally rectangular-shaped pad having front and back sides as well as opposite side edges and opposite end edges,
a releasable attachment means for attaching an edge of said heating member below and parallel to a support member, and
an electric current supply cord power cord having an electric current control means.

2. A towel warmer as defined in claim 1 wherein said releasable attachment means is a first type of attachment means releasably attached to the front and back side of one edge of said heating member and a second type of attachment means having opposite ends wherein one end is releasably attached to the first type of attachment means attached to the front side of said heating member and the opposite end is releasably attached to the first type of attachment means attached to the back side of said heating member.

3. A towel warmer as defined in claim 1 wherein said attachment means is a hook and loop system.

4. A towel warmer as defined in claim 1 wherein said releasable attachment means is a first type of attachment means consisting of one or more holes located along one edge of said heating member and a second type of attachment means consisting of one or more straps which can be strung through said one or more holes, over said support member and tied off to secure said heating member to said support member.

5. A towel warmer as defined in claim 4 wherein said first type of attachment means consists of one or more holes with mounted grommets.

6. A towel warmer as in claim 1 wherein said heating member has an electric power supply plug for attaching said electric current supply cord to a power supply and an electric current control means for controlling the level of electric power supplied to the heating member.

7. A towel warmer as in claim 6 wherein said electric current control means is capable of automatically shutting the electric current off after a pre-set period of time.

8. A method of warming a towel comprising,
attaching a rectangular heating member to a support member using releasable attachment means, wherein said rectangular heating member has an electric supply cord having a an electric current control means and an electric power supply plug, allowing said rectangular heating member to hang below and parallel to said support member,
attaching said electric power supply plug to an electric power supply means,
draping a towel over said support member so that opposite ends of said towel hang below said support member and next to opposite sides of said heating member, and
heating said towel by controlling the electric current to said heating member using the electric current control means.

9. The method of heating a towel as described in claim 8 further comprising,
attaching said heating member to said support means using releasable attachment means wherein said releasable attachment means consisting of a first and second type of releasable attachment means, where said first type of releasable attachment means is attached in one or more locations on opposite sides and along one edge of said heating member, where said second type of releasable attachment means having opposite ends is attached to said first type of attachment means by releasably attaching one end of said second type of attachment means to the first type of attachment means attached along one side of said heating member, looping the second type of attachment means over the support member and attaching the opposite end of the second type of attachment means to the first type of attachment means attached along the opposite side of said heating member.
